(19) United States
(12) Patent Application Publication
(10) Pub. No.: US 2005/0057092 A1
(43) Pub. Date: Mar. 17, 2005

(54) Hydraulic pressure controller

(76) Inventor: Taro Segawa, Kariya (JP)

Correspondence Address: BURNS DOANE SWECKER & MATHIS L L P, POST OFFICE BOX 1404, ALEXANDRIA, VA, 22313-1404, US

(21) Appl. No.: 10/939,411

(22) Filed: Sep. 14, 2004

(30) Foreign Application Priority Data
Sep. 17, 2003 (JP) 2003-324916

(51) Int. Cl. B60T 8/42

(52) U.S. Cl. 303/116.4

(57) ABSTRACT

A hydraulic pressure controller for controlling the behavior of a vehicle on which the hydraulic pressure controller is mounted. It includes a hydraulic unit having a block in which are mounted hydraulic pumps and solenoid valves. A motor for driving the pumps and an electronic control unit for controlling the solenoid valves and the motor are joined to the block of the hydraulic unit. The motor is joined to the block of the hydraulic unit by threaded bolts. The threaded bolts are located radially inward of the radially outer surface of the motor. With this arrangement, the dimensions of the block can be determined independently of the outer diameter of the motor. It is thus possible to minimize the size and cost of the hydraulic pressure controller.

### BACKGROUND OF THE INVENTION

This invention relates to a compact hydraulic pressure controller mounted on a vehicle and comprising a hydraulic unit for controlling the behavior of the vehicle by supplying controlled hydraulic pressure to wheel brakes, and an electric motor for driving hydraulic pumps in the hydraulic unit, the motor being joined to the hydraulic unit.

Modern motor vehicles are equipped with various hi-tech devices such as an anti-lock brake system (ABS), which obviates imminent lock-up of any vehicle wheel, thereby achieving efficient braking, a vehicle stability control (VSC) system, which controls brake pressures to individual wheel cylinders to keep a stable state of the vehicle, and a traction control (TRC) system. These devices have an electronic control unit (ECU) for controlling the entire system to adjust hydraulic pressures supplied to the individual wheel cylinders.

The hydraulic unit, which includes solenoid valves and an actuator such as a pump unit, the motor, and the ECU are usually joined together into a hydraulic pressure controller module because such a module is compact and low in manufacturing cost. One of the most important factors that determines the size of such a module is how the motor is joined to the hydraulic unit. JP patent publication 8-219127 discloses a unit comprising hydraulic unit including pumps and a motor for driving the pumps in the hydraulic unit. The casing of the motor is joined to the block of the hydraulic unit by caulking or frictional engagement of threaded portions.

JP patent publication 2002-510260 discloses a motor-drive unit comprising a hydraulic unit including solenoid valves, an electric motor including an armature, and an electronic control unit, in which the casing of the motor and the cover protecting the electronic control unit are fixed to the block of the hydraulic unit using common mounting members (shafts with reduced diameter) under equal preloads and equal contact pressures.

JP patent publication 2002-536234 proposes a hydraulic pressure control device comprising a hydraulic unit and a motor, in which the motor casing is joined to the block of the hydraulic unit by use of a mounting bolt that passes through the motor casing and the block of the hydraulic unit at a position radially outward of the armature of the motor, and another mounting bolt that extends through a leg formed on the radially outer surface of the motor at its end near the hydraulic unit and the block of the hydraulic unit.

In any of the above-described conventional devices, at least one of the joint members that join the motor casing, the block of the hydraulic unit and the housing of the electronic control unit is located radially outward of the radially outer surface of the motor casing. More specifically, in JP patent publication 8-219127, the motor casing is joined to the block of the hydraulic unit by caulking or frictional engagement along or radially outward of the radially outer surface of the motor. In JP patent publication 2002-510260, the bolts are located radially outward of the radially outer surface of the motor. In JP patent publication 2002-536234, one of the mounting bolts are located radially outward of the radially outer surface of the motor.

The block of the hydraulic unit is made of an expensive material such as an aluminum alloy, and thus it should be as small in volume as possible. But as mentioned above, in the conventional arrangements, since the joint members are provided radially outward of the radially outer surface of the motor, the width of the block of the hydraulic unit has to be necessarily greater than the outer diameter of the motor. This makes it impossible to sufficiently reduce the volume of the block of the hydraulic unit.

The outer diameter of the motor is determined by its output. Three different motors having different outputs and thus different outer diameters from each other are usually prepared depending on the size of the motor vehicle and one of them is selected according to the output required. Since the width of the block of the hydraulic unit is practically determined by the outer diameter of the motor selected, it is necessary to prepare three hydraulic unit blocks having different widths from each other. It is of course not desirable to prepare three different hydraulic unit blocks. One way to avoid this disadvantage is to use uniform hydraulic unit blocks having a width corresponding to the largest one of the outer diameters of the three different motors. But this solution is not desirable, either, because such a large block is simply not necessary and thus a waste of material if the motor used in combination has a smaller outer diameter.

In JP publication 2002-536234, one of the bolts extends through the motor from outside the motor casing. When tightening this bolt, the motor casing may be deformed, thus deteriorating sealability. Also, this bolt has to be passed through the narrow space between the outer periphery of the armature and the magnet therearound. It is difficult to insert the bolt without interfering either of the armature and the magnet. Thus, a separate guide member is usually necessary to pass the bolt through the motor.

An object of the present invention is to minimize the size of a block of a hydraulic unit of a hydraulic pressure controller comprising the hydraulic unit and a motor for driving pumps in the hydraulic unit, independently of the outer diameter of the motor so that a single common block can be joined to a motor having any outer diameter.

### SUMMARY OF THE INVENTION

According to this invention, there is provided a hydraulic pressure controller comprising a hydraulic unit including a hydraulic pump and electric actuators and adapted to supply, based on electrical control signals, controlled hydraulic pressure to external devices to control the behavior of a vehicle on which the hydraulic pressure controller is mounted, and an electric motor for driving the hydraulic pump, the electric motor including a motor casing having an end plate facing the hydraulic unit, the motor having a radially outer surface, the end plate of the motor casing being joined to the hydraulic unit by means of a joint member, the joint member being located radially inward of the radially outer surface of the motor.

With this arrangement, the width of the block of the hydraulic unit can be determined independently of the outer diameter of the motor. Thus, its width and thus its volume can be determined freely. That is, its dimensions can be determined at minimum values necessary to control the behavior of the vehicle on which the hydraulic pressure controller is mounted. Freedom of design of the hydraulic unit block further increases by providing the joint member or members radially inward of the radialy outer surface of the armature of the motor.

Preferably, the hydraulic pressure controller further comprises an electronic control unit including a driver circuit and adapted to drive the electric actuators of the hydraulic unit and the motor through the driver circuit, the hydraulic unit having first and second sides opposite to each other, wherein the end plate of the motor casing is joined to the first side of the hydraulic unit and the electronic control unit is joined to the second side of the hydraulic unit.

The hydraulic pressure controller is used in a system for controlling the behavior of the vehicle on which this system is mounted. Such systems include an anti-lock brake system (ABS), a vehicle stability control (VSC) system, and a traction control (TRC) system. Its hydraulic unit includes a block in or on which are mounted hydraulic pumps, solenoid valves, a reservoir, etc. Hydraulic pressure produced in the pumps is supplied to wheel cylinders through selected solenoid valves and returned into the reservoir through selected solenoid valves to individually control the hydraulic pressures in the wheel cylinders, thereby optimally controlling the behavior of the vehicle.

### BRIEF DESCRIPTION OF THE DRAWINGS

Other features and objects of the present invention will become apparent from the following description made with reference to the accompanying drawings, in which:

FIG. 1 is a perspective view of a hydraulic pressure controller embodying the present invention;

FIG. 2 is an exploded perspective view of the same;

FIG. 3 is a partially cutaway plan view of the same;

FIG. 4 is an enlarged sectional view taken along line IV-IV of FIG. 1;

FIGS. 5A-5C are partial sectional views of other embodiments, showing their joint means;

FIGS. 6A and 6B are partial sectional views of still another embodiment, showing its joint means;

FIGS. 7A and 7B are partial sectional views of other embodiments, showing their joint means;

FIG. 8 is a partially cutaway plan view of a further embodiment, showing its joint means;

FIG. 9 is a partial sectional view of an embodiment similar to the embodiment of FIG. 8 but having a seal member provided at a different position from the seal member of FIG. 8; and

FIG. 10 is a partial sectional view of an embodiment similar to the embodiment of FIG. 8 but having a joint means mounted at different positions from the joint means of FIG. 8.

### DETAILED DESCRIPTION OF THE PREFERRED EMBODIMENT

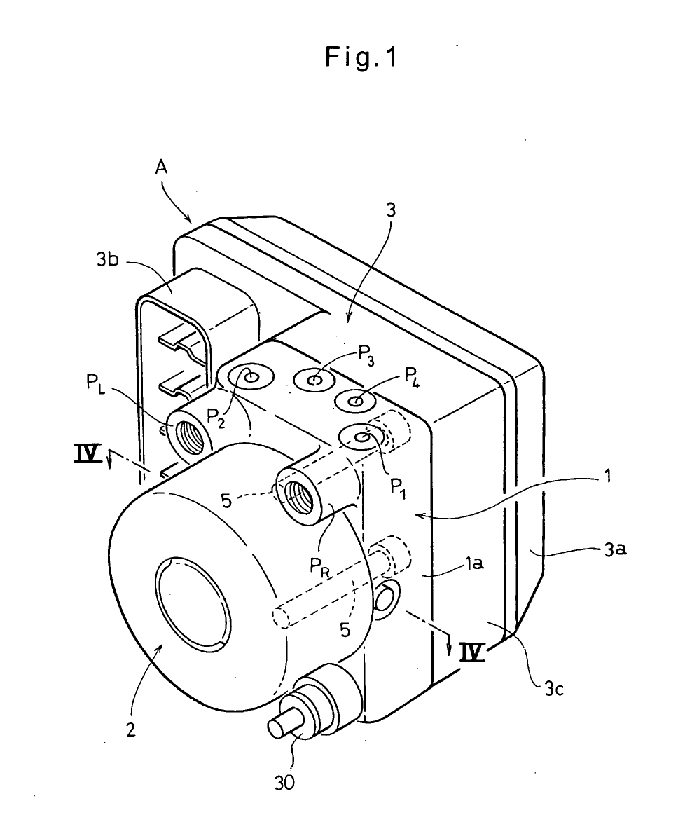

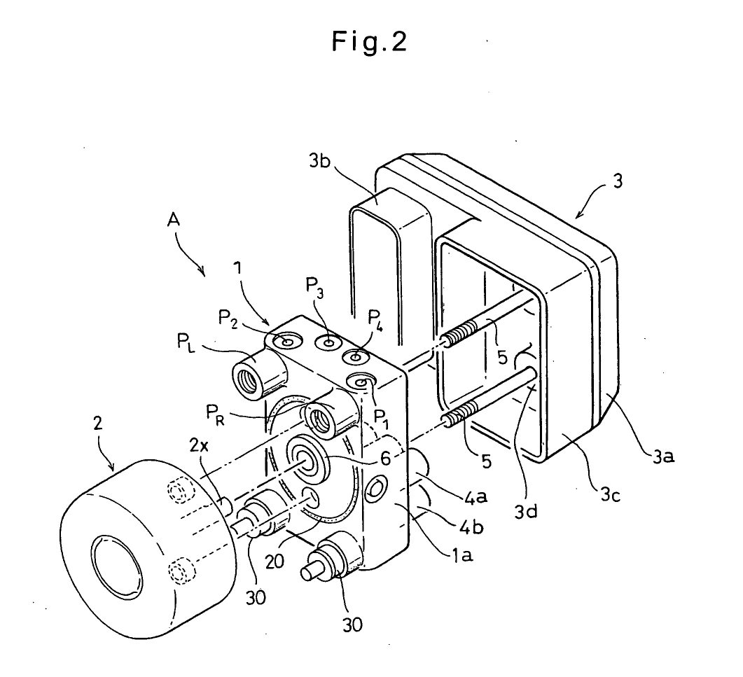

Now referring to FIGS. 1 and 2, the hydraulic pressure controller A of the embodiment comprises a hydraulic unit 1 including hydraulic pumps 10 (FIG. 4), solenoid valves 4a and 4b (FIG. 2) and a reservoir (not shown), an electric motor 2 for driving the hydraulic pumps 10, and an electronic control unit 3 for controlling and driving the solenoid valves, the motor and other electric actuators. The hydraulic unit 1 has a block 1a joined to a cover 3c of a housing 3a of the electronic control unit 3. The motor 2 has a motor casing 2a joined to the block 1a of the hydraulic unit 1. The hydraulic pressure controller A shown is for an anti-lock brake system (ABS).

The block 1a of the hydraulic unit 1 is a thick, box-shaped element made of an aluminum alloy and has a cavity in which are mounted the hydraulic pumps 10 and the reservoir. The solenoid valves 4a and 4b are provided in a plurality of pairs in upper and lower tiers on the back wall of the block 1a. The upper solenoid valves 4a are pressure increase valves while the lower ones 4b are pressure reduction valves. They are both two-position changeover valves and similar in structure but not exactly the same due to their difference in function. These elements of the hydraulic unit 1 are connected together by fluid passages formed in the block 1a. In a conventional hydraulic pressure controller of this type, the block 1a has a width greater than the diameter of the motor 2. However, the block 1a of the hydraulic pressure controller according to the present invention has a width smaller than the diameter of the motor 2. We will explain later how this is possible in the present invention.

Ports P1-P4 and PL and PR are provided in the top of the block 1a. Pipes are connected to the respective ports to supply hydraulic pressure to and from various elements of the control system in which the hydraulic pressure controller is mounted. Specifically, the pipes connected to the ports P1 and P2 extend to brake cylinders. The pipes connected to the ports PL and PR extend to the master cylinder, not shown. Brake fluid discharged through the solenoid valves 4a and 4b are returned to the reservoir. Brake fluid in the reservoir is supplied to the suction ports of the hydraulic pumps 10 through fluid lines. The hydraulic pressure controller A is supported on the vehicle body through a mount 30.

The motor 2 is an ordinary motor including an armature/rotor 2R, a permanent magnet, a brush, etc. which are encased in the motor casing 2a. Not all of the elements of the motor 2 are shown here because they are well-known and are not the point of the invention. As shown in FIG. 2, the motor 2 is secured to the hydraulic unit 1 by threaded bolts 5. The threaded bolts 5 are located radially inward of the radially outer surface of the motor 2 and the radially outer surface of the armature 2R. Thus, the width of the block 1a of the hydraulic unit 1 can be made smaller than the outer diameter of the motor 2.

The housing 3a of the electronic control unit 3 is a closed box made of a plastic resin. On one side of the housing 3a, a connector 3b to which electric codes are connected and the cover 3c are provided, both integrally with the housing 3a. The hydraulic unit 1 is secured to the cover 3c. The interior of the housing 3a is divided into two chambers in the thickness direction by a partitioning plate. On one side of the partitioning plate, a circuit board is mounted which carries an electronic control circuit in the form of a microcomputer, switches, bus bars and other electronic parts. On the other side of the partitioning wall, coils for driving the solenoid valves are mounted.

The microcomputer contains a program for anti-lock control. As mentioned above, the solenoid valves 4a and 4b are mounted on the back wall of the block 1a of the hydraulic unit 1. The cover 3c has a recess in which are received the solenoid valves 4a and 4b. On the inner surface of the end wall opposite the open end of the housing 3c, mounting seats 3d are provided to support threaded bolts 5 (FIG. 2).

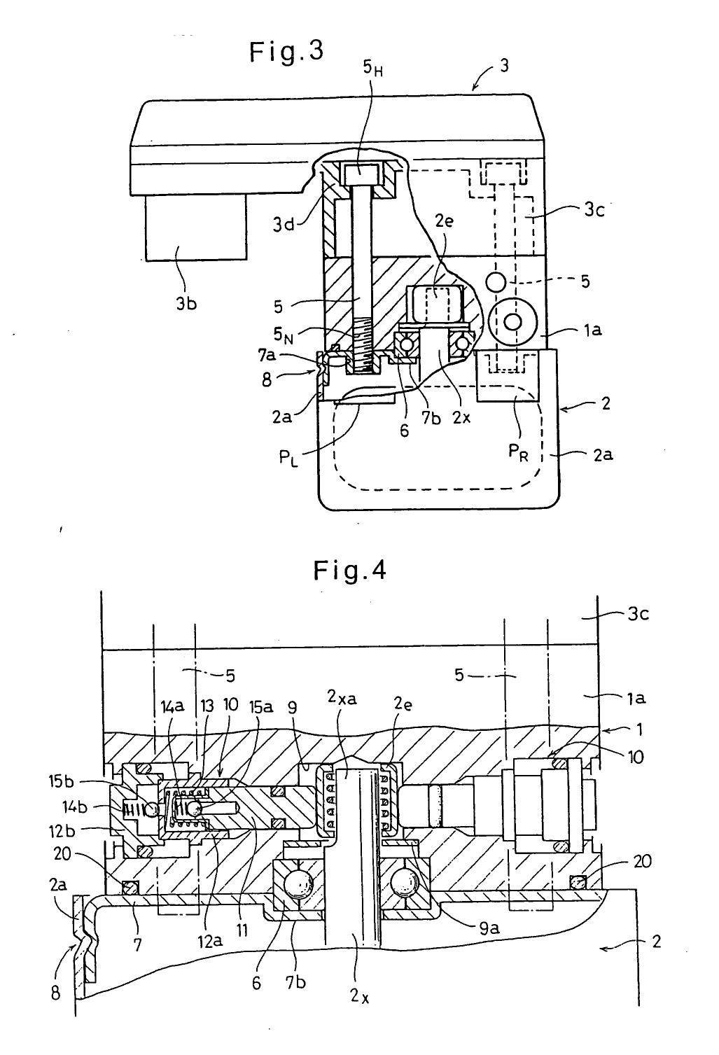

FIG. 3 shows how the motor 2, hydraulic unit 1 and the electronic control unit 3 are secured together with the bolts 5. The bolts 5 have a head 5H at one end thereof and a thread 5N at the other end. At its end facing the hydraulic unit 1, the interior of the motor 2 is closed by an end plate 7, which has cylindrical bosses 7a (FIG. 3) protruding toward the motor 2. Each boss 7a is formed with a thread on the inner wall thereof. The bolts 5 extend through the block 1a of the hydraulic unit 1 with their heads 5H engaged in the corresponding mounting seats 3d and their threads 5N in threaded engagement with the threads formed on the inner wall of the corresponding bosses 7a, thereby joining and securing the motor 2, hydraulic unit 1 and electronic control unit 3 together.

FIGS. 3 and 4 are plan views of the hydraulic pressure controller and show both of the two bolts 5. As shown in FIG. 2, however, the two bolts 5 are actually arranged right over and right under the output shaft 2×of the motor 2. In a strict sense, therefore, FIGS. 3 and 4 are not correct drawings. Rather in FIGS. 3 and 4, the bolts 5 are intentionally shown to be horizontally offset from the output shaft 2x in order to more clearly show how the bolts 5 are mounted.

But the two bolts 5 may be arranged so as to be horizontally offset from each other, provided they do not interfere with any of the hydraulic pumps 10 and fluid passages. Also, more than two such bolts 5 may be used. In this case, they should be arranged at equal angular intervals. For example, if three such bolts 5 are used, they are arranged at 120-degree intervals. Also, the three members 1, 2 and 3 may be joined together using joint means other than the bolts 5. Some examples are shown later.

FIG. 4 shows the hydraulic pumps 10. The pumps 10 and the bolts 5 have to be arranged so as not to interfere with each other. The pumps 10 each includes a plunger 11, a cylinder 12a, a plug 12b, a return spring 13, a suction spring 14a, a discharge spring 14b, and check balls 15a and 15b. Since the pumps 10 themselves are not the point of the invention, their detailed structure and function are not described here.

Each of the right and left pumps 10 is used to supply pressure to one of the two brake lines. The plungers 11 are arranged diametrically opposite to each with their tips in contact with a cam 2e received in a cam chamber 9 formed in the block 1a at its center. The cam 2e is mounted on a small-diameter end 2xa of the output shaft 2x of the motor 2. The small-diameter end 2xa has its axis offset from the axis of the output shaft 2x. Thus, as the output shaft 2x and thus the cam 2e rotate, the plungers 11 are alternately driven in a known manner.

The output shaft 2x of the motor 2 is rotatably supported on a ball bearing 6 which is held in position between the end plate 7 and the block 1a, received in a shallow recess formed in the center of the end plate 7 and a recess formed in the block 1a. The cam 2e is separated from the ball bearing 6 by a partitioning plate 9a, which prevents axial movement of the cam 2e. Since the bearing 6 is pressed into the shallow recess 7b, its outer ring cannot rotate. Other means for preventing the rotation of the outer ring of the bearing 6 is shown later.

As shown in FIG. 4, the motor casing 2a is preferably formed with radially inward protrusions near its end, and the end plate 7 is preferably formed with corresponding recesses in its flange portion. With this arrangement, the motor 2 can be easily mounted on the block 1a simply by pressing the protrusions of the motor casing 2a into the recesses of the end plate 7. But the end plate 7 and the motor casing 2a may be joined by different means such as bolts and nuts or hooks. The motor 2 is sealed from the hydraulic unit 1 by a seal member (O-ring), which is ordinarily provided radialy outward of the joint means or bolts 5.

The hydraulic pressure controller A of the embodiment is an element of an ABS, which is a system for controlling and adjusting the braking force applied by the driver to an optimum level. Since an ABS itself is well-known, only the relationship between the ABS and the hydraulic pressure controller A is briefly described.

While not shown, fluid lines are provided in the ABS such that the hydraulic pressure produced when the brake pedal is depressed is supplied to a booster, where the hydraulic pressure is amplified, and the amplified hydraulic pressure is distributed through the master cylinder to the hydraulic unit 1.

Based on an anti-lock brake control program stored in the electronic control unit 3, the electronic control unit 3 controls the solenoid valves 4 and the motor 2 through a driver circuit to adjust the hydraulic pressure and supply the adjusted hydraulic pressure to wheel cylinders or return hydraulic fluid into the reservoir through fluid lines. Since such an anti-lock brake control program is well-known, its detailed description is omitted here. Needless to say, the hydraulic pressure controller according to the present invention can be used not only for an ABS but for a vehicle stability control (VSC) system or a traction control (TRC) system.

Because the threaded bolts 5 are located radially inward of the radially outer surface of the motor 2 as well as radially inward of the radially outer surface of the armature 2R, the width of the block 1a of the hydraulic unit 1 can be made smaller than the outer diameter of the motor 2 as well as smaller than the outer diameter of the armature of the motor 2. Thus, the area of the surface of the block 1a facing the motor 2 can be determined independently of the outer diameter of the motor, so that it is possible to minimize the volume of the block 1a. This in turn makes it possible to use a single hydraulic unit 1 in combination with a motor 2 of any size.

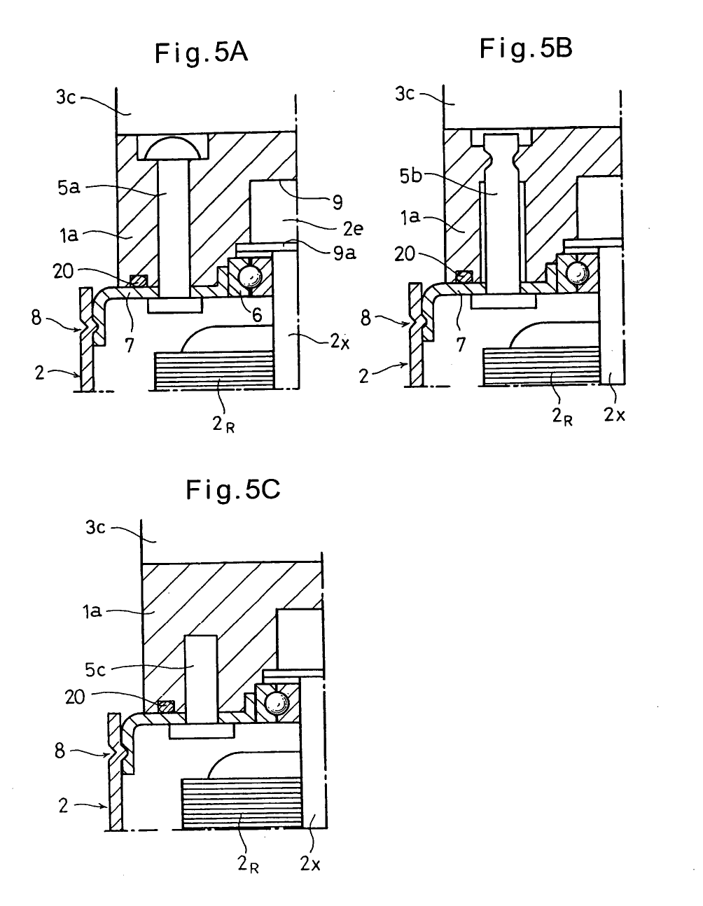

FIGS. 5A-5C show joint means other than the threaded bolts 5. In FIG. 5A, rivets 5a are used to join the block 1a to the motor 2. In FIG. 5B, the block 1a is joined to the motor 2 by passing non-threaded rods 5b each having a head at one end thereof through the end plate 7 and the block 1a and caulking the other end thereof. In FIG. 5C, the block 1a is joined to the motor 2 by pressing non-threaded short shafts 5c each having a head at one end thereof into the end plate 7 and the block 1a. In any of the embodiments of FIGS. 5A-5C, the rivets or shafts are located radially inward of the radially outer surface of the armature 2R of the motor 2. In any of the embodiments of FIGS. 5A-5C, the rivets or the shafts shown are not used to join the cover 3c of the electronic control unit 3 to the hydraulic unit 1. This is because the cover 3c and the housing 3a are made of a synthetic resin and cannot withstand caulking and press-fitting. The cover 3c is thus joined to the hydraulic unit 1 using separate joint means such as bolts and nuts or screws (not shown).

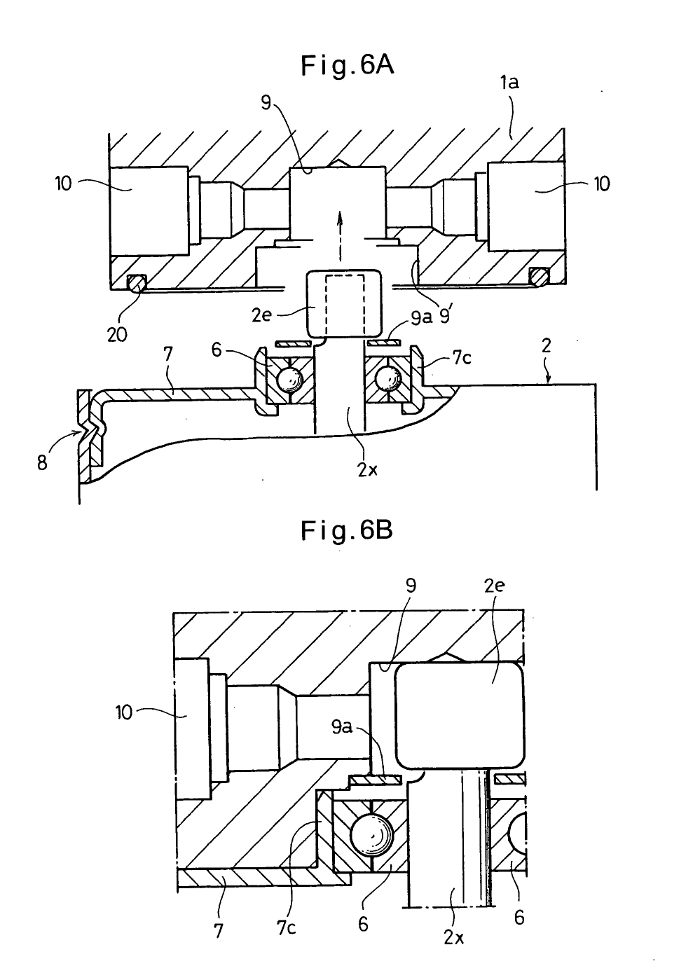

In the embodiment of FIGS. 6A and 6B, the end plate 7 is formed with a boss 7c. In assembling the hydraulic pressure controller, with the output shaft 2×of the motor 2 supported on the ball bearing 6, the entire motor 2 is moved toward the block 1a until the ball bearing 6 is received in the recess of the boss 7c, and the boss 7c is pressed into a bearing chamber 9′. When the boss 7c is pressed into the chamber 9′, it is pressed against the outer ring of the bearing 6. Thus, the outer ring is prevented from rotating. Thus, in this embodiment, simultaneously when the motor 2 is mounted to the block 1a, the outer ring of the bearing 6 is restrained so as not to rotate. Since the motor 2 is joined to the block 1a by pressing the boss 7c into the chamber 9′, no separate joint means such as the bolts 5, rivets 5a or shafts 5b or 5c are not necessary and not used in this embodiment. But they may be used too.

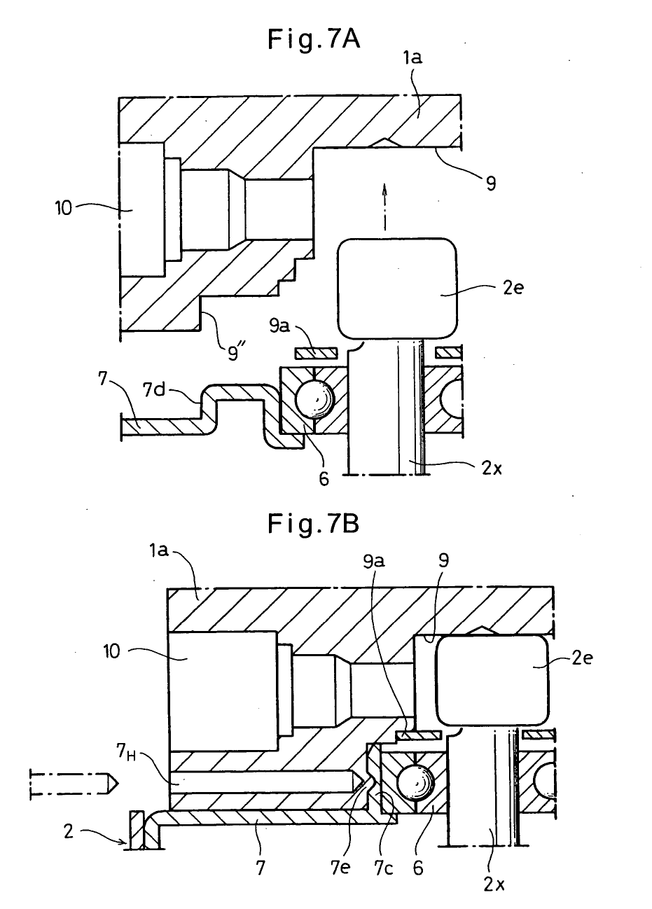

In the embodiment of FIG. 7A, instead of the flange-shaped boss 7c of FIGS. 6A and 6B, a boss 7d having a substantially U-shaped section is pressed into a bearing chamber 9″ which comprises a large-diameter portion for receiving the boss 7d and a small-diameter portion for receiving the partitioning plate 9a. Otherwise, the embodiment of FIG. 7A is the same as the embodiment of FIGS. 6A and 6B.

The embodiment of FIG. 7B differs from the embodiment of FIGS. 6A and 6B only in that a lateral hole 7H is formed in the block 1a so that its inner end is located near the inner wall of the chamber 9′. In this embodiment, with the boss 7c pressed into the chamber 9′, a caulking tool (shown by chain line) having a pointed tip is inserted into the hole 7H until its pointed tip abuts the inner end of the hole 7H and the outer end of the tool is struck to form a protrusion 7e. The protrusion 7e serves to more rigidly join the block 1a to the end plate 7 and also to more strongly restrain the outer ring of the bearing 6 from rotating.

In any of these embodiments, means for joining the motor 2 to the block 1a are provided radially inward of the radially outer surface of the armature 2R. This makes it possible to use a single hydraulic unit 1 in combination with a motor 2 of any size. Because the size of such a hydraulic unit 1 is not dependent upon the size of the motor 2 used together, its size and cost, as well as the size and cost of the entire hydraulic pressure controller, can be reduced to a necessary minimum. By using a common hydraulic unit 1 having a width smaller than the outer diameter of any of the motors 2 used, it is not necessary to change the radial positions of the joint means according to the size of the motor to be joined to the hydraulic unit.

In some of the drawings, the seal member 20 (O-ring) is not shown. But it is to be understood that it is omitted from the drawings only and not from the actual device. Also, the seal member 20 is provided radially outward of the joint means to protect the joint means from water and other foreign matter.

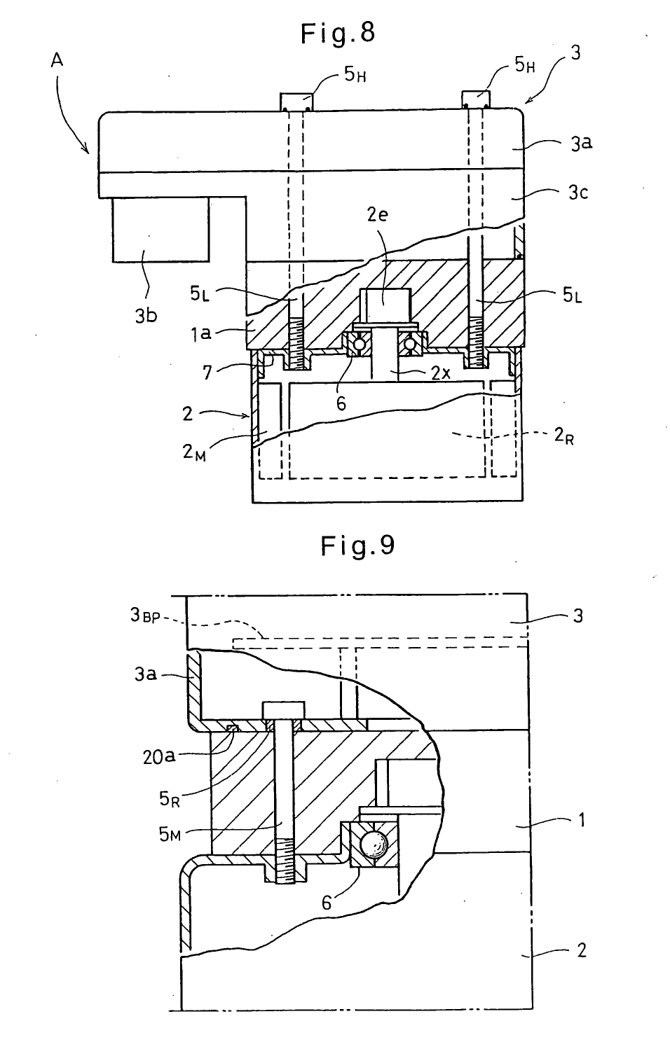

In the embodiment of FIG. 8, the electronic control unit 3, the hydraulic unit 1 and the motor 2 are joined together by passing threaded bolts 5L longer than the threaded bolts 5 of the first embodiment through the housing 3a, cover 3c and block 1a. Seal members are provided between the bottoms of the heads 5H of the bolts 5L and the top surface of the housing 3a. Another seal is provided between the bottom end of the cover 3c and the top surface of the block 1a. Again, the bolts 5L are located radially inward of the radially outer surface of the armature 2R of the motor 2. Otherwise, this embodiment is the same as the first embodiment.

In the embodiment of FIG. 9, the cover 3c is omitted. The electronic control unit 3, the hydraulic unit 1 and the motor 2 are joined together by passing threaded bolts 5M through the bottom wall of the housing 3a and the block 1a of the hydraulic unit 1. A seal member 20a (O-ring) is provided between the bottom surface of the housing 3a and the top surface of the block 1, radially outward of the bolts 5a. Thus, there is no need to provide a seal between the bottom of the head of each bolt and the bottom wall of the housing 3a as in the embodiment of FIG. 8. But preferably, the neck of each bolt, i.e. the top end of the shank connecting to the head is retained by a metallic collar 5R.

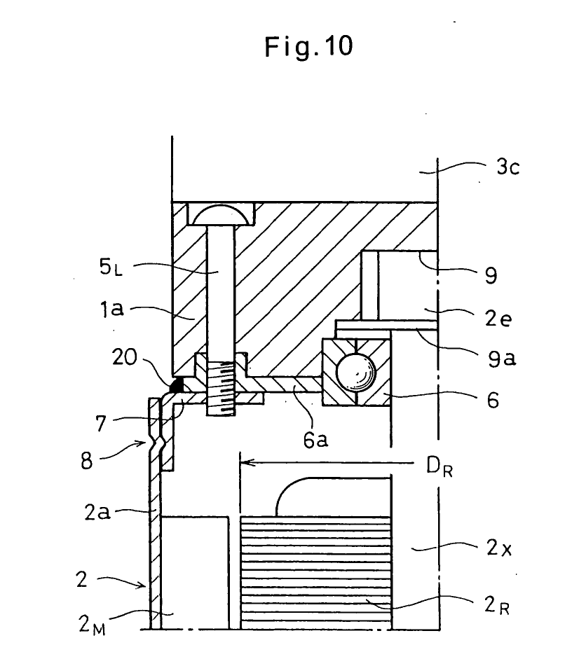

While all the bolts, rivets and shafts 5, 5a, 5b, 5c, 5L, and 5M of the embodiments of FIGS. 1-5, 8 and 9 are located radially inward of the outer diameter DR of the armature 2R of the motor 2, the bolts 5L of the embodiment of FIG. 10 are located radially outward of the outer diameter DR of the armature 2R but radially inward of the outer diameter of the motor casing 2a. The joint means of the embodiments of FIGS. 1-5, 8 and 9 may also be located radially outward of the outer diameter DR of the armature 2R and radially inward of the outer diameter of the motor casing 2a.

Preferably, however, the joint means of FIGS. 1-5, 8 and 9 are provided radially inward of the outer diameter of the armature of the motor, because with this arrangement, the width of the block 1a and thus its volume can be made further small.

The hydraulic pressure controller according to this invention can be used for various systems for controlling the behavior of a vehicle such as an ABS, a traction control system and a VSC system.

1. A hydraulic pressure controller comprising a hydraulic unit including a hydraulic pump and electric actuators, said hydraulic unit being adapted to adjust hydraulic pressure based on electrical control signals and supply the thus adjusted hydraulic pressure to external devices to control the behavior of a vehicle on which the hydraulic pressure controller is mounted, and an electric motor for driving said hydraulic pump, said electric motor including a motor casing having an end plate facing said hydraulic unit, said motor having a radially outer surface, said end plate of said motor casing being joined to said hydraulic unit by means of a joint member, said joint member being located radially inward of said radially outer surface of said motor.

2. The hydraulic pressure controller of claim 1 further comprising an electronic control unit including a driver circuit and adapted to drive said electric actuators of said hydraulic unit and said motor through said driver circuit, said hydraulic unit having first and second sides opposite to each other, wherein said end plate of said motor casing is joined to said first side of said hydraulic unit and said electronic control unit is joined to said second side of said hydraulic unit by means of said joint member.

3. The hydraulic pressure controller of claim 1 wherein said motor has an armature, said joint member being located radially inward of the radially outer surface of said armature.

4. The hydraulic pressure controller of claim 1 wherein said hydraulic unit includes a block member, said joint member extending through said block member.

5. The hydraulic pressure controller of claim 1 wherein said hydraulic unit includes a block member, said joint member being pressed into a hole formed in said block member.

6. The hydraulic pressure controller of claim 1 wherein said joint member is provided at a bearing supporting an output shaft of said motor.

7. The hydraulic pressure controller of claim 1 wherein a space between said end plate of said motor and the opposed surface of said block member is sealed with a seal member, said seal member being located radially outward of said joint member and radially inward of the radially outer surface of said motor.
